(19) United States
(12) Patent Application Publication
(10) Pub. No.: US 2026/0223861 A1
(43) Pub. Date: Aug. 6, 2026

(54) NATURAL PESTICIDAL COMPOSITIONS AND METHODS OF CONTROLLING ARTHROPODS

(71) Applicant: TERRAMERA, INC., Vancouver (CA)

(72) Inventor: Nathan WOODBURY, Burnaby (CA)

(21) Appl. No.: 19/152,634

(22) PCT Filed: Jan. 30, 2024
(86) PCT No.: PCT/CA2024/050105

§ 371 Date: Jul. 31, 2025

Related U.S. Application Data
(60) Provisional application No. 63/482,531, filed on Jan. 31, 2023.

(51) Int. Cl. A01N 65/16; A01N 25/30

(52) U.S. Cl. CPC A01N 65/16; A01N 25/30

(57) ABSTRACT

Pesticidal compositions comprising a pesticidal natural oil (and/or a derivative, a synthetic analog, and/or an agriculturally compatible salt thereof), and an anionic surfactant are disclosed. The anionic surfactant may be, e.g., sodium lauryl sulfate, sodium laureth sulfate, sodium myreth sulfate, ammonium lauryl sulfate, and/or docusate sodium salt. The pesticidal natural oil may be, e.g., oleic acid, butyl lactate, thyme oil, thymol, wintergreen oil, methyl salicylate, and/or geraniol.

### CROSS-REFERENCE TO RELATED APPLICATIONS

This application claims priority to, and the benefit of, U.S. provisional patent application No. 63/482,531 filed 31 Jan. 2023 entitled Natural Pesticidal Compositions and Methods of Controlling Arthropods, the entirety of which is incorporated by reference herein for all purposes.

### TECHNICAL FIELD

The present disclosure relates generally to pesticidal compositions and methods for delivery of pesticidal active ingredients, and particularly to natural pesticidal compositions for controlling arthropods and other invertebrates.

### BACKGROUND

Pesticides are important compositions for use in domestic, agricultural, industrial and commercial settings, such as to provide for control of unwanted pests and/or pathogens. Providing for effective pest control is of high importance in many such settings, since pests and/or other pathogens if not controlled can cause loss and or destruction of crops or other plants; harm to animals, humans or other beneficial or desired organisms; and/or damage to structures. There remains a need for environmentally safe and effective pesticides or compounds that enhance the efficacy of pesticides and for methods of enhancing the efficacy of pesticides so that pesticides can be used in a more environmentally safe and effective manner.

In domestic and commercial settings, for example, a variety of pests are known to be vectors of disease, a source of uncleanliness, and otherwise undesirable. Among these are various arthropods, such as those belonging to the classes Insecta, Chilopoda, Diplopoda, Collembola, Crustacea, and/or Arachnida. These may include, for example, cockroaches (e.g. German cockroaches, American cockroaches, and/or brown banded cockroaches), ants (e.g. pavement ants, field ants, harvester ants, carpenter ants, Argentine ants, odorous ants, pyramid ants, and/or crazy ants), bed bugs, boxelder bugs, stink bugs, silverfish, firebrats, beetles (e.g. carpet beetles, elm leaf beetles, weevils), earwigs, crickets, fleas, flies (e.g. larvae and/or landed adults, such as house flies, bottle flies, flesh flies, fruit flies), moths (e.g. larvae and/or landed adults), millipedes, centipedes, sowbugs, pillbugs, spiders, ticks, and mites. Certain arthropods are known to cause significant damage to seeds and ornamental and crop plants in domestic, agricultural, industrial and commercial.

Conventional pesticides can be potentially toxic to humans, animals, and/or the environment and may persist long after they are applied. They can also be costly or undesirable for other reasons. Therefore it is typically beneficial to farmers, consumers and the surrounding environment to use the least amount of conventional pesticides as possible, while continuing to control pest growth in order to maximize crop yield. In a growing number of cases, conventional pesticide use has also resulted in growing resistance to certain conventional pesticides by pest organisms, leading to reduced effectiveness, requiring greater doses of pesticidal chemicals, or even failure of certain types of pesticides as viable control agents. As a result, many conventional pesticides are being phased out or otherwise restricted from use.

Natural or biologically-derived pesticidal compounds (including synthetic analogs thereof) have been proposed for use in place of some conventional pesticides, in order to attempt to reduce the toxicity, health and environmental risks associated with chemical pesticide use. However, some natural or biologically-derived pesticides have proven less efficacious or consistent in their performance in comparison with competing conventional pesticides, or may require relatively high concentrations to achieve acceptable levels of efficacy, which has limited their adoption as control agents in pesticide markets.

There is a general desire for natural pesticidal compositions that are efficacious against one or more pests. Alternatively, or in addition, there is a desire for natural pesticidal compositions that can, in suitable circumstances, reduce the amount of pesticidal natural compounds required to obtain desired or acceptable levels of control of pests, and/or which reduce the incidence of toxic residues after application.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods which are meant to be exemplary and illustrative, not limiting in scope. In various embodiments, one or more of the above-described problems have been reduced or eliminated, while other embodiments are directed to other improvements.

Aspects of the invention provide a synergistic pesticidal composition comprising a pesticidal active ingredient comprising a pesticidal natural oil and/or a derivative, a synthetic analog, and/or an agriculturally compatible salt thereof having a concentration in a range of approximately 1.25% to 40%; an anionic surfactant comprising at least one of: a sulfate-, phosphate-, and/or sulfonate-containing ionic compound having a concentration in a range of approximately 0.625% to 20%; and a solvent.

In some embodiments, the anionic surfactant comprises at least one of: sodium lauryl sulfate, sodium laureth sulfate, sodium myreth sulfate, ammonium lauryl sulfate, potassium lauryl sulfate, sodium pareth sulfate, ammonium lauryl ether sulfate and docusate sodium salt. In some embodiments, the anionic surfactant comprises sodium lauryl sulfate.

In some embodiments, the pesticidal active ingredient has a concentration in a range of at approximately least one of: 1.25% to 40%, 1.38% to 38%, 1.5% to 36%, 1.63% to 34%, 1.75% to 32%, 1.88% to 30%, 2% to 28%, 2.13% to 26%, 2.25% to 24%, 2.38% to 22%, and 2.5% to 20%.

In some embodiments, the anionic surfactant has a concentration in a range of at approximately least one of: 0.63% to 20%, 0.69% to 19%, 0.75% to 18%, 0.81% to 17%, 0.88% to 16%, 0.94% to 15%, 1% to 14%, 1.06% to 13%, 1.13% to 12%, 1.19% to 11%, and 1.25% to 10%.

In some embodiments, the pesticidal active ingredient comprises at least one of: oleic acid, butyl lactate, thyme oil, thymol, wintergreen oil, methyl salicylate, geraniol, and combinations thereof.

In some embodiments, the pesticidal active ingredient comprises oleic acid and has a concentration in a range of approximately 2.5% to 40%; and the anionic surfactant has a concentration in a range of approximately 2.5% to 20%. In some embodiments, the synergistic pesticidal composition further comprises isopropyl alcohol having a concentration in a range of approximately 5% to 40%.

In some embodiments, the pesticidal active ingredient comprises butyl lactate and has a concentration in a range of approximately 1.25% to 40%, and preferably has a concentration in a range of approximately 2.5% to 40%; and the anionic surfactant has a concentration in a range of approximately 1.25% to 20%. In some embodiments, the synergistic pesticidal composition further comprises glycerol monooleate having a concentration in a range of approximately 0.625% to 2.5%. In some embodiments, the synergistic pesticidal composition further comprises lecithin having a concentration in a range of approximately 0.625% to 2.5%. In some embodiments, the synergistic pesticidal composition further comprises isopropyl alcohol having a concentration in a range of approximately 2.5% to 40%. In some embodiments, the synergistic pesticidal composition further comprises NaCl having a concentration in a range of approximately 1.25% to 5%.

In some embodiments, the pesticidal active ingredient comprises at least one of: thyme oil and thymol and has a concentration in a range of approximately 2.5% to 40%; and the anionic surfactant has a concentration in a range of approximately 0.625% to 20%. In some embodiments, the synergistic pesticidal composition further comprises lecithin having a concentration in a range of approximately 0.625% to 5%. In some embodiments, the synergistic pesticidal composition further comprises butyl lactate having a concentration in a range of approximately 2.5% to 40%.

In some embodiments, the pesticidal active ingredient comprises at least one of: wintergreen oil, methyl salicylate, and geraniol, the pesticidal active ingredient having a concentration in a range of approximately 1.25% to 40%; and the anionic surfactant has a concentration in a range of approximately 1.25% to 20%.

In some embodiments, the pesticidal active ingredient comprises geraniol and a second compound comprising at least one of wintergreen oil and methyl salicylate. In some embodiments, geraniol and the second compound have a concentration ratio of approximately 1.25:10 to 10:1.25. In some embodiments, geraniol and the second ingredient collectively have a concentration in a range of approximately 2.5% to 20%.

In some embodiments, the synergistic pesticidal composition further comprises lecithin having a concentration in a range of approximately 0.625% to 2.5%. In some embodiments, the synergistic pesticidal composition further comprises glycerol monooleate having a concentration in a range of approximately 0.625% to 2.5%. In some embodiments, the synergistic pesticidal composition further comprises isopropyl alcohol having a concentration in a range of approximately 2.5% to 40%. In some embodiments, the synergistic pesticidal composition further comprises oleic acid having a concentration in a range of approximately 2.5% to 40%. In some embodiments, the synergistic pesticidal composition further comprises butyl lactate having a concentration in a range of approximately 1.25% to 40%. In some embodiments, the synergistic pesticidal composition further comprises NaCl having a concentration in a range of approximately 1.25% to 10%.

In some embodiments, the solvent comprises water having a concentration in a range of approximately 40% to 95%.

Aspects of a present disclosure provide a synergistic pesticidal concentrate comprising: a pesticidal active ingredient comprising a pesticidal natural oil and/or a derivative, a synthetic analog, and/or an agriculturally compatible salt thereof having a concentration in a range of approximately 1.25% to 40%; and an anionic surfactant comprising at least one of: a sulfate-, phosphate-, and/or sulfonate-containing ionic compound; wherein a concentration ratio of the pesticidal active ingredient to the anionic surfactant is in a range of approximately 1.25:20 to 40:0.625.

In some embodiments, the concentrate comprises an emulsifiable concentrate and the concentrate further comprises an emulsifier.

In some embodiments, the anionic surfactant comprises at least one of: sodium lauryl sulfate, sodium laureth sulfate, sodium myreth sulfate, ammonium lauryl sulfate, potassium lauryl sulfate, sodium pareth sulfate, ammonium lauryl ether sulfate and docusate sodium salt. In some embodiments, the anionic surfactant comprises sodium lauryl sulfate.

In some embodiments, the concentration ratio of the pesticidal active ingredient to the anionic surfactant is in a range of approximately at least one of: 1.25:20 to 40:0.63, 1.38:19 to 38:0.69, 1.50:18 to 36:0.75, 1.63:17 to 34:0.81, 1.75:16 to 32:0.88, 1.88:15 to 30:0.94, 2.00:14 to 28:1, 2.13:13 to 26:1.06, 2.25:12 to 24:1.13, 2.38:11 to 22:1.19, and 2.50:10 to 20:1.25.

In some embodiments, the pesticidal active ingredient comprises at least one of: oleic acid, butyl lactate, thyme oil, thymol, wintergreen oil, methyl salicylate, geraniol, and combinations thereof.

In some embodiments, the pesticidal active ingredient comprises oleic acid and a concentration ratio of the oleic acid to the anionic surfactant is in a range of approximately 2.5:20 to 40:2.5. In some embodiments, a concentration ratio of the oleic acid to the isopropyl alcohol is in a range of approximately 40:5 to 2.5:40.

In some embodiments, the pesticidal active ingredient comprises butyl lactate and a concentration ratio of the butyl lactate to the anionic surfactant is in a range of approximately 1.25:20 to 40:1.25. In some embodiments, a concentration ratio of the butyl lactate to the glycerol monooleate is in a range of approximately 1.25:0.625 to 2.5:40. In some embodiments, a concentration ratio of the butyl lactate to the anionic surfactant is in a range of approximately 1.25:2.5 to 40:0.625. In some embodiments, a concentration ratio of the butyl lactate to the isopropyl alcohol is in a range of approximately 1.25:40 to 40:2.5. In some embodiments, a concentration ratio of the butyl lactate to the NaCl is in a range of approximately 1.25:5 to 40:1.25.

In some embodiments, the pesticidal active ingredient comprises at least one of: thyme oil and thymol and a concentration ratio of the pesticidal active ingredient to the anionic surfactant is in a range of approximately 2.5:20 to 40:0.625. In some embodiments, a concentration ratio of the pesticidal active ingredient to the lecithin is in a range of approximately 2.5:5 to 40:0.625. In some embodiments, a concentration ratio of the pesticidal active ingredient to the butyl lactate is in a range of approximately 2.5:40 to 40:2.5.

In some embodiments, the pesticidal active ingredient comprises at least one of: wintergreen oil, methyl salicylate, and geraniol and a concentration ratio of the pesticidal active ingredient to the anionic surfactant is in a range of approximately, 1.25:20 to 40:1.25. In some embodiments, the pesticidal active ingredient comprises geraniol and a second compound comprising at least one of wintergreen oil and methyl salicylate. In some embodiments, a concentration ratio of geraniol to the second compound is in a range of approximately 1.25:10 to 10:1.25. In some embodiments, a concentration ratio of the geraniol and the second ingredient to the anionic surfactant is in a range of approximately 2.5:20 to 20:1.25. In some embodiments, a concentration ratio of the pesticidal active ingredient to the lecithin is in a range of approximately 1.25:2.5 to 40:0.625, and preferable in a range of approximately 2.5:2.5 to 20:0.625. In some embodiments, a concentration ratio of the pesticidal active ingredient to the glycerol monooleate is in a range of approximately 1.25:2.5 to 40:0.625. In some embodiments, a concentration ratio of the pesticidal active ingredient to the isopropyl alcohol is in a range of approximately 1.25:40 to 40:2.5. In some embodiments, a concentration ratio of the pesticidal active ingredient to the oleic acid is in a range of approximately 1.25:40 to 40:2.5. In some embodiments, a concentration ratio of the pesticidal active ingredient to the butyl lactate is in a range of approximately 1.25:40 to 40:1.25. In some embodiments, a concentration ratio of the pesticidal active ingredient to the NaCl is in a range of approximately 1.25:10 to 40:1.25.

Aspects of the present disclosure provide a method of synergistically enhancing the pesticidal activity of a pesticidal composition adapted to control at least one target pest organism comprising: providing at least one pesticidal active ingredient active for said at least one target pest organism comprising a pesticidal natural oil and/or a derivative, a synthetic analog, and/or an agriculturally compatible salt thereof having a concentration in a range of approximately 1.25% to 40%; and adding to the at least one pesticidal active ingredient a synergistically effective concentration of an anionic surfactant comprising at least one of: a sulfate-, phosphate-, and/or sulfonate-containing ionic compound having a concentration in a range of approximately 0.625% to 20% to form said synergistic pesticidal composition. In some embodiments, the synergistic pesticidal composition further comprises any of the features described above.

Aspects of the present disclosure provide a method of controlling at least one target pest organism comprising: providing at least one pesticidal active ingredient active for said at least one target pest organism comprising a pesticidal natural oil and/or a derivative, a synthetic analog, and/or an agriculturally compatible salt thereof having a concentration in a range of approximately 1.25% to 40%; adding to the at least one pesticidal active ingredient a synergistically effective concentration of an anionic surfactant comprising at least one of: a sulfate-, phosphate-, and/or sulfonate-containing ionic compound having a concentration in a range of approximately 0.625% to 20% to form said synergistic pesticidal composition; and applying said synergistic pesticidal composition in a pesticidally effective concentration to control said at least one target pest organism. In some embodiments, the synergistic pesticidal composition further comprises any of the features described above.

Aspects of the present disclosure provide a synergistic pesticidal composition comprising: a pesticidal active ingredient comprising wintergreen oil and/or a derivative, a synthetic analog, and/or an agriculturally compatible salt thereof having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%; an anionic surfactant comprising sodium lauryl sulfate having a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%, and preferably having a concentration of approximately 10%; lecithin having a concentration in a range of approximately at least one of: 0.625% to 2.5%, 0.66% to 2.4%, 0.69% to 2.3%, 0.74% to 2.1%, 0.78% to 2%, 0.83% to 1.9%, 0.89% to 1.8%, 0.96% to 1.6%, 1.04% to 1.5%, 1.14% to 1.4%, and 1.25% to 1.3%, and preferably having a concentration of approximately 1.25%; and butyl lactate having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%. In some embodiments, the synergistic pesticidal composition further comprises water having a concentration in a range of approximately 57.5% to 93.75%.

Aspects of the present disclosure provide a synergistic pesticidal composition comprising: a pesticidal active ingredient comprising: wintergreen oil and/or a derivative, a synthetic analog, and/or an agriculturally compatible salt thereof having a concentration in a range of approximately at least one of: 1.25% to 5%, 1.38% to 4.75%, 1.5% to 4.5%, 1.63% to 4.25%, 1.75% to 4%, 1.88% to 3.75%, 2% to 3.5%, 2.13% to 3.25%, 2.25% to 3%, and 2.38% to 2.75%, and preferably having a concentration of approximately 2.5%; and geraniol and/or a derivative, a synthetic analog, and/or an agriculturally compatible salt thereof having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%; an anionic surfactant comprising sodium lauryl sulfate having a concentration in a range of approximately at least one of: 2.5% to 20%, 2.75% to 19%, 3% to 18%, 3.25% to 17%, 3.5% to 16%, 3.75% to 15%, 4% to 14%, 4.25% to 13%, 4.5% to 12%, 4.75% to 11%, 5% to 10%; and isopropyl alcohol having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%.

In some embodiments, the sodium lauryl sulfate has a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%. In some embodiments, the sodium lauryl sulfate has a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%, and preferably having a concentration of approximately 10%.

In some embodiments, the synergistic pesticidal composition comprises water having a concentration a in range of approximately 55% to 93.125%.

In addition to the exemplary aspects and embodiments described above, further aspects and embodiments will become apparent by reference to the drawings and by study of the following detailed descriptions.

### DESCRIPTION

Throughout the following description specific details are set forth in order to provide a more thorough understanding to persons skilled in the art. However, well known elements may not have been shown or described in detail to avoid unnecessarily obscuring this disclosure. Accordingly, the description and drawings are to be regarded in an illustrative, rather than a restrictive, sense.

The present disclosure describes pesticidal compositions comprising a pesticidal natural oil (and/or a derivative, a synthetic analog, and/or an agriculturally compatible salt thereof), and an anionic surfactant such as sodium lauryl sulfate. Alternatively, or in addition, the anionic surfactant may comprise sodium lauryl sulfate, sodium laureth sulfate, sodium myreth sulfate, ammonium lauryl sulfate, potassium lauryl sulfate, sodium pareth sulfate, ammonium lauryl ether sulfate and docusate sodium salt. The pesticidal natural oil may comprise, for example, oleic acid, butyl lactate, thyme oil, thymol, wintergreen oil, methyl salicylate, and/or geraniol.

Various tested combinations of such ingredients were found to have synergistic efficacy, as disclosed in greater detail herein. In some embodiments, the pesticidal natural oil (and/or a derivative, a synthetic analog, and/or an agriculturally compatible salt thereof) has a concentration in the pesticidal composition in a range of approximately 1.25% to 40%, 1.38% to 38%, 1.5% to 36%, 1.63% to 34%, 1.75% to 32%, 1.88% to 30%, 2% to 28%, 2.13% to 26%, 2.25% to 24%, 2.38% to 22%, and/or 2.5% to 20%. In some embodiments, the anionic surfactant has a concentration in the pesticidal composition in a range of approximately 0.63% to 20%, 0.69% to 19%, 0.75% to 18%, 0.81% to 17%, 0.88% to 16%, 0.94% to 15%, 1% to 14%, 1.06% to 13%, 1.13% to 12%, 1.19% to 11%, and/or 1.25% to 10%.

### Experimental Methods

In the following in vitro examples, various compounds were combined and the resulting composition was tested for efficacy. Each composition was mixed using a magnetic stir bar at room temperature (21° C.), except as otherwise noted herein. Ingredients with melting points below 40° C., such as oleic acid and glycerol monooleate, were heated to liquid phase prior to mixing. Water-soluble and/or -miscible ingredients such as sodium lauryl sulfate, isopropanol, lecithin, and glycerol monooleate were dissolved in the water fraction of the composition before other ingredients. In compositions comprising lecithin and/or glycerol monooleate, the water fraction was first heated to at least 40° C. and stirred for at least 30 minutes to properly dissolve the lecithin and/or glycerol monooleate. Water-insoluble and/or -immiscible ingredients, such as wintergreen oil, geraniol, oleic acid, and Na oleate, were dissolved and mixed as a separate fraction (the water-insoluble fraction). The water-insoluble fraction was then mixed with the water-soluble fraction by gentle stirring. All tested compositions comprised the tested compounds in solution with water.

It will be understood that other preparation methods are possible. For example, ingredients may be mixed in a different order. For instance, in suitable circumstances one may create a concentrate by first adding the water-insoluble and/or -immiscible ingredients, then surfactants, then water-soluble and/or -miscible ingredients, and finally diluting with water.

Each composition was tested for efficacy by spraying the composition on German cockroaches and observing the number of knocked-down and dead (including moribund) insects twice, once at 5 minutes after spraying and once at 48 hours after spraying. Either such measure of knock-down and mortality can be important in certain contexts. For example, 5-minute knock-down and mortality can be important in consumer contexts, as efficacy is often assessed over a short interval in such contexts. Shorter intervals, such as 30 seconds or 1 minute, are also or alternatively sometimes used in such contexts. As another example, 48-hour knock-down and mortality can be important in agricultural or industrial contexts, as total reduction in pest pressure may be more readily assessed over longer periods in such contexts. Accordingly, observing synergy under either measure can be sufficient to demonstrate the synergistic efficacy of a formulation, regardless of whether synergy is observed under the other measure.

German cockroaches were selected as representative arthropods because they tend to be among the hardest arthropods to control individually. It is expected that formulations exhibiting efficacy against German cockroaches will also exhibit efficacy against other arthropods (particularly those in the classes Insecta, Chilopoda, Diplopoda, Collembola, Crustacea, and/or Arachnida). These may include, for example, other cockroaches (e.g. American cockroaches and/or brown banded cockroaches), ants (e.g. pavement ants, field ants, harvester ants, carpenter ants, Argentine ants, odorous ants, pyramid ants, and/or crazy ants), bed bugs, boxelder bugs, stink bugs, silverfish, firebrats, beetles (e.g. carpet beetles, elm leaf beetles, weevils), earwigs, crickets, fleas, flies (e.g. larvae and/or landed adults, such as house flies, bottle flies, flesh flies, fruit flies), moths (e.g. larvae and/or landed adults), millipedes, centipedes, sowbugs, pillbugs, spiders, ticks, and mites.

Ingredients were also tested for efficacy on their own (in dilution in water to provide the same concentration of the ingredient as in the tested compositions) using the same testing procedure. An expected efficacy for each formulation was determined based on the ingredients' individual tested efficacies based on the Colby equation, as described in greater detail by Ferry, Nancy; Stanley, Bruce H.; and Armel, Gregory (2005). “DESIGN AND ANALYSIS OF BIOLOGICAL ASSAYS OF MIXTURES,” Conference on Applied Statistics in Agriculture. https://doi.org/10.4148/2475-7772.1133. Compositions with efficacy greater than this expected efficacy were determined to show synergistic efficacy.

The degree of synergistic efficacy is sometimes quantified by comparing the observed efficacy to the expected efficacy. There are several ways to do this, and in general it is not necessary to do so to confirm that synergy has been observed. One measure for quantifying the degree of synergistic efficacy of a formulation is to calculate a so-called “synergy ratio” by determining the ratio of the observed efficacy to the expected efficacy, for example as described by Gisi U. (1996) Synergism, antagonism, and additive action of fungicides in mixtures. American Phytopathological Society Vol. 86, No. 11, pp 1273-1279, which is hereby incorporated herein by reference for all purposes.

Although synergy ratios can assist in detecting the presence or absence of synergy (i.e. by providing a value greater than 1 when synergy is present, or less than 1 in the event of antagonism), such measures have limitations if there is a desire to compare the relative synergy of formulations. In particular, a synergy ratio can overemphasize relative efficacy rather than absolute efficacy; for instance, a formulation that provides 12% observed efficacy against 2% expected efficacy could have a synergy ratio of approximately 6, whereas a formulation that provides 100% efficacy against 50% expected efficacy could have a synergy ratio of approximately 2. In certain contexts, and particularly in certain contexts involving pesticidal efficacy, raising 50% efficacy to 100% is likely to be the more significant synergistic effect (relative to raising 2% efficacy to 12%). This is not reflected by calculating ratios and can be addressed by additionally or alternatively using other measures of synergy. For instance, one may calculate the difference between expected and observed efficacy. As another example, one may determine the “synergy factor” based on a logistic regression, e.g. as described by Cortina-Borja M, Smith A D, Combarros O, Lehmann D J. The synergy factor: a statistic to measure interactions in complex diseases. BMC Res Notes. 2009 Jun. 15; 2:105. doi: 10.1186/1756-0500-2-105. PMID: 19527493; PMCID: PMC2706251, which is hereby incorporated herein by reference for all purposes. Other measures of synergy may be applicable as well or in the alternative.

The present disclosure is not limited to a specific measure for quantifying synergy. Some formulations provide strong relative synergistic efficacy; determining a synergy ratio may assist for certain such formulations. Some formulations provide strong absolute synergistic efficacy; determining a difference-based synergy measure may assist for certain such formulations. Some formulations provide strong synergistic efficacy under other measures. All formulations disclosed herein have been experimentally demonstrated to provide greater observed synergy than expected synergy at at least one of the 5-minute and 48-hour intervals and so are considered to have demonstrated synergistic efficacy.

All concentrations set out in the tables herein are weight per weight (w/w) unless otherwise noted.

### Example 1: Compositions Comprising Oleic Acid and Sodium Lauryl Sulfate

Compositions comprising oleic acid (a representative long-chain fatty acid), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 1
5-minute efficacy of compositions comprising
oleic acid and sodium lauryl sulfate

| | Observed | Expected |
|---|---|---|
| Composition | Efficacy | Efficacy |
| Sodium lauryl sulfate (5%) | 7% | |
| Sodium lauryl sulfate (10%) | 0% | |
| Oleic Acid (5%) | 0% | |
| Oleic Acid (10%) | 20% | |
| Oleic Acid (20%) | 5% | |
| Isopropyl alcohol (20%) | 13% | |
| Oleic Acid (20%), Sodium lauryl | 100% | 22% |
| sulfate (5%), Isopropyl alcohol (20%) | | |
| Oleic Acid (20%), Sodium lauryl | 93% | 18% |
| sulfate (10%), Isopropyl alcohol (20%) | | |
| Oleic Acid (10%), Sodium lauryl | 93% | 34% |
| sulfate (5%), Isopropyl alcohol (20%) | | |
| Oleic Acid (10%), Sodium lauryl | 73% | 29% |
| sulfate (10%), Isopropyl alcohol (20%) | | |
| Oleic Acid (5%), Sodium lauryl | 44% | 19% |
| sulfate (5%), Isopropyl alcohol (20%) | | |
| Oleic Acid (5%), Sodium lauryl | 60% | 7% |
| sulfate (10%), Isopropyl alcohol (10%) | | |

TABLE 2
48-hour efficacy of compositions comprising
oleic acid and sodium lauryl sulfate

| | Observed | Expected |
|---|---|---|
| Composition | Efficacy | Efficacy |
| Sodium lauryl sulfate (5%) | 7% | |
| Sodium lauryl sulfate (10%) | 0% | |
| Oleic Acid (5%) | 0% | |
| Oleic Acid (10%) | 20% | |
| Oleic Acid (20%) | 5% | |
| Isopropyl alcohol (20%) | 13% | |
| Oleic Acid (20%), Sodium lauryl | 100% | 22% |
| sulfate (5%), Isopropyl alcohol (20%) | | |
| Oleic Acid (20%), Sodium lauryl | 93% | 18% |
| sulfate (10%), Isopropyl alcohol (20%) | | |
| Oleic Acid (10%), Sodium lauryl | 93% | 34% |
| sulfate (5%), Isopropyl alcohol (20%) | | |
| Oleic Acid (10%), Sodium lauryl | 73% | 29% |
| sulfate (10%), Isopropyl alcohol (20%) | | |
| Oleic Acid (5%), Sodium lauryl | 44% | 19% |
| sulfate (5%), Isopropyl alcohol (20%) | | |
| Oleic Acid (5%), Sodium lauryl | 60% | 7% |
| sulfate (10%), Isopropyl alcohol (10%) | | |

These results indicate synergistic efficacy for compositions of oleic acid having a concentration in a range of approximately 2.5% to 40%, 1.25% to 40%, 1.38% to 38%, 1.5% to 36%, 1.63% to 34%, 1.75% to 32%, 1.88% to 30%, 2% to 28%, 2.13% to 26%, 2.25% to 24%, 2.38% to 22%, and/or 2.5% to 20%; and the anionic surfactant having a concentration in a range of approximately 2.5% to 20%, 2.6% to 19%, 2.8% to 18%, 2.9% to 17%, 3.1% to 16%, 3.3% to 15%, 3.6% to 14%, 3.8% to 13%, 4.2% to 12%, 4.5% to 11%, and/or 5% to 10%.

### Example 2: Compositions Comprising Butyl Lactate and Sodium Lauryl Sulfate

Compositions comprising butyl lactate (a representative carboxylic acid ester), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 3
5-minute efficacy of compositions comprising
butyl lactate and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (10%) | 0% | |
| Isopropyl alcohol (20%) | 0% | |
| Butyl Lactate (2.5%) | 0% | |
| Butyl Lactate (5%) | 13% | |
| Butyl Lactate (10%) | 7% | |
| Butyl Lactate (20%) | 13% | |
| NaCl (2.5%) | 0% | |
| Lecithin (1.25%) | 0% | |
| Butyl Lactate (10%), Sodium | 20% | 7% |
| Lauryl Sulfate (2.5%) | | |
| Butyl Lactate (10%), Sodium | 73% | 14% |
| Lauryl Sulfate (5%) | | |
| Butyl Lactate (5%), Sodium | 27% | 13% |
| Lauryl Sulfate (10%) | | |
| Butyl Lactate (10%), Sodium | 60% | 7% |
| Lauryl Sulfate (10%) | | |
| Butyl Lactate (20%), Sodium | 20% | 13% |
| Lauryl Sulfate (10%) | | |
| Butyl Lactate (20%), Sodium | 40% | 13% |
| Lauryl Sulfate (10%), Glycerol | | |
| Monooleate (1.25%) | | |
| Butyl Lactate (20%), Isopropyl | 80% | 13% |
| alcohol (20%) | | |
| Butyl Lactate (2.5%), Sodium | 7% | 0% |
| Lauryl Sulfate (2.5%), Lecithin | | |
| (1.25%) | | |
| Butyl Lactate (5%), Sodium | 20% | 13% |
| Lauryl Sulfate (10%), | | |
| Lecithin (1.25%) | | |
| Butyl Lactate (10%), Sodium | 33% | 7% |
| Lauryl Sulfate (2.5%), Lecithin | | |
| (1.25%) | | |
| Butyl Lactate (20%), Sodium | 80% | 19% |
| Lauryl Sulfate (5%), Lecithin (1.25%) | | |
| Butyl Lactate (20%), Sodium | 60% | 13% |
| Lauryl Sulfate (10%), Lecithin | | |
| (1.25%) | | |
| Butyl Lactate (20%), Lecithin | 27% | 13% |
| (1.25%), Isopropyl alcohol (10%) | | |
| Butyl Lactate (20%), Sodium | 20% | 13% |
| Lauryl Sulfate (10%), Lecithin | | |
| (1.25%), Isopropyl alcohol (20%) | | |
| Butyl Lactate (5%), Sodium | 20% | 13% |
| Lauryl Sulfate (10%), Lecithin | | |
| (1.25%), Isopropyl alcohol (20%) | | |
| Butyl Lactate (20%), Sodium | 80% | 13% |
| Lauryl Sulfate (10%), Lecithin | | |
| (1.25%), Isopropyl alcohol (5%) | | |
| Butyl Lactate (10%), Sodium | 100% | 7% |
| Lauryl Sulfate (2.5%), Lecithin | | |
| (1.25%), Isopropyl alcohol (10%) | | |
| Butyl Lactate (10%), Sodium | 20% | 7% |
| Lauryl Sulfate (2.5%), Lecithin | | |
| (1.25%), NaCl (2.5%), Isopropyl | | |
| alcohol (10%) | | |

TABLE 4
48-hour efficacy of compositions comprising
butyl lactate and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (10%) | 0% | |
| Isopropyl alcohol (20%) | 0% | |
| Butyl Lactate (2.5%) | 0% | |
| Butyl Lactate (5%) | 13% | |
| Butyl Lactate (10%) | 7% | |
| Butyl Lactate (20%) | 13% | |
| NaCl (2.5%) | 0% | |
| Lecithin (1.25%) | 0% | |
| Butyl Lactate (10%), Sodium | 33% | 7% |
| Lauryl Sulfate (2.5%) | | |
| Butyl Lactate (10%), Sodium | 100% | 14% |
| Lauryl Sulfate (5%) | | |
| Butyl Lactate (5%), Sodium | 40% | 13% |
| Lauryl Sulfate (10%) | | |
| Butyl Lactate (10%), Sodium | 60% | 7% |
| Lauryl Sulfate (10%) | | |
| Butyl Lactate (20%), Sodium | 100% | 7% |
| Lauryl Sulfate (10%) | | |
| Butyl Lactate (20%), Sodium | 100% | 7% |
| Lauryl Sulfate (10%), Glycerol | | |
| Monooleate (1.25%) | | |
| Butyl Lactate (20%), Isopropyl | 100% | 19% |
| alcohol (20%) | | |
| Butyl Lactate (2.5%), Sodium | 13% | 0% |
| Lauryl Sulfate (2.5%), Lecithin | | |
| (1.25%) | | |
| Butyl Lactate (5%), Sodium | 27% | 13% |
| Lauryl Sulfate (10%), Lecithin | | |
| (1.25%) | | |
| Butyl Lactate (10%), Sodium | 33% | 7% |
| Lauryl Sulfate (2.5%), Lecithin | | |
| (1.25%) | | |
| Butyl Lactate (20%), Sodium | 93% | 7% |
| Lauryl Sulfate (5%), Lecithin | | |
| (1.25%) | | |
| Butyl Lactate (20%), Sodium | 100% | 7% |
| Lauryl Sulfate (10%), Lecithin | | |
| (1.25%) | | |
| Butyl Lactate (20%), Lecithin | 33% | 7% |
| (1.25%), Isopropyl alcohol | | |
| (10%) | | |
| Butyl Lactate (20%), Sodium | 100% | 7% |
| Lauryl Sulfate (10%), Lecithin | | |
| (1.25%), Isopropyl alcohol | | |
| (20%) | | |
| Butyl Lactate (5%), Sodium | 100% | 13% |
| Lauryl Sulfate (10%), Lecithin | | |
| (1.25%), Isopropyl alcohol (20%) | | |
| Butyl Lactate (20%), Sodium | 100% | 7% |
| Lauryl Sulfate (10%), Lecithin | | |
| (1.25%), Isopropyl alcohol (5%) | | |
| Butyl Lactate (10%), Sodium | 100% | 7% |
| Lauryl Sulfate (2.5%), Lecithin | | |
| (1.25%), Isopropyl alcohol | | |
| (10%) | | |
| Butyl Lactate (10%), Sodium | 100% | 14% |
| Lauryl Sulfate (2.5%), Lecithin | | |
| (1.25%), NaCl (2.5%), Isopropyl | | |
| alcohol (10%) | | |

These results indicate synergistic efficacy for compositions of butyl lactate having a concentration in a range of approximately 1.25% to 40%, 1.32% to 38%, 1.39% to 36%, 1.47% to 34%, 1.56% to 32%, 1.67% to 30%, 1.79% to 28%, 1.92% to 26%, 2.08% to 24%, 2.27% to 22%, and/or 2.5% to 20%; and the anionic surfactant having a concentration in a range of approximately 1.25% to 40%, 1.32% to 38%, 1.39% to 36%, 1.47% to 34%, 1.56% to 32%, 1.67% to 30%, 1.79% to 28%, 1.92% to 26%, 2.08% to 24%, 2.27% to 22%, and/or 2.5% to 20%.

### Example 3: Compositions Comprising Thyme Oil and Sodium Lauryl Sulfate

Compositions comprising thyme oil (a pesticidal natural oil comprising primarily thymol, as well as other ingredients such as thymol p-cymene, carvacrol, linalool, β-caryphyllene, and terpinen-4-ol), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 5
5-minute efficacy of compositions comprising
thyme oil and sodium lauryl sulfate

| | Observed | Expected |
|---|---|---|
| Composition | Efficacy | Efficacy |
| Sodium Lauryl Sulfate (1.25%) | 0% | |
| Sodium Lauryl Sulfate (2.5%) | 0% | |
| Sodium Lauryl Sulfate (10%) | 0% | |
| Lecithin (1.25%) | 0% | |
| Butyl Lactate (5%) | 13% | |
| Butyl Lactate (10%) | 7% | |
| Butyl Lactate (20%) | 13% | |
| Thyme Oil (5%) | 0% | |
| Thyme Oil (10%) | 0% | |
| Thyme Oil (20%) | 60% | |
| Thyme Oil (10%), Sodium | 80% | 7% |
| Lauryl Sulfate (1.25%), Lecithin | | |
| (1.25%), Butyl Lactate (10%) | | |
| Thyme Oil (5%), Sodium | 100% | 13% |
| Lauryl Sulfate (10%), Lecithin | | |
| (1.25%), Butyl Lactate (20%) | | |
| Thyme Oil (20%), Sodium | 100% | 65% |
| Lauryl Sulfate (2.5%), Lecithin | | |
| (1.25%), Butyl Lactate (5%) | | |
| Thyme Oil (5%), Sodium | 40% | 13% |
| Lauryl Sulfate (1.25%), Lecithin | | |
| (1.25%), Butyl Lactate (5%) | | |

TABLE 6
48-hour efficacy of compositions comprising
thyme oil and sodium lauryl sulfate

| | Observed | Expected |
|---|---|---|
| Composition | Efficacy | Efficacy |
| Sodium Lauryl Sulfate (1.25%) | 0% | |
| Sodium Lauryl Sulfate (2.5%) | 0% | |
| Sodium Lauryl Sulfate (10%) | 0% | |
| Lecithin (1.25%) | 0% | |
| Butyl Lactate (5%) | 13% | |
| Butyl Lactate (10%) | 7% | |
| Butyl Lactate (20%) | 13% | |
| Thyme Oil (5%) | 0% | |
| Thyme Oil (10%) | 0% | |
| Thyme Oil (20%) | 60% | |
| Thyme Oil (10%), Sodium Lauryl | 100% | 81% |
| Sulfate (1.25%), Lecithin | | |
| (1.25%), Butyl Lactate (10%) | | |
| Thyme Oil (5%), Sodium Lauryl | 100% | 7% |
| Sulfate (10%), Lecithin (1.25%), | | |
| Butyl Lactate (20%) | | |
| Thyme Oil (20%), Sodium | 100% | 94% |
| Lauryl Sulfate (2.5%), Lecithin (1.25%), | | |
| Butyl Lactate (5%) | | |
| Thyme Oil (5%), Sodium Lauryl | 60% | 13% |
| Sulfate (1.25%), Lecithin (1.25%), | | |
| Butyl Lactate (5%) | | |

These results indicate synergistic efficacy for compositions of thyme oil having a concentration in a range of approximately 2.5% to 40%, 2.63% to 38%, 2.78% to 36%, 2.94% to 34%, 3.13% to 32%, 3.33% to 30%, 3.57% to 28%, 3.85% to 26%, 4.17% to 24%, 4.55% to 22%, and/or 5% to 20%; and the anionic surfactant having a concentration in a range of approximately 0.63% to 20%, 0.66% to 19%, 0.69% to 18%, 0.74% to 17%, 0.78% to 16%, 0.83% to 15%, 0.89% to 14%, 0.96% to 13%, 1.04% to 12%, 1.14% to 11%, and/or 1.25% to 10%.

### Example 4: Compositions Comprising Wintergreen Oil and Sodium Lauryl Sulfate

Compositions comprising wintergreen oil (a pesticidal natural oil comprising methyl salicylate), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 7
5-minute efficacy of compositions comprising
wintergreen oil and sodium lauryl sulfate

| | Observed | Expected |
|---|---|---|
| Composition | Efficacy | Efficacy |
| Sodium Lauryl Sulfate (1.25%) | 0% | |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (20%) | 0% | |
| Lecithin (1.25%) | 0% | |
| Glycerol Monooleate (1.25%) | 0% | |
| Butyl Lactate (5%) | 13% | |
| Butyl Lactate (10%) | 7% | |
| Butyl Lactate (20%) | 13% | |
| Wintergreen Oil (2.5%) | 0% | |
| Wintergreen Oil (5%) | 0% | |
| Wintergreen Oil (10%) | 7% | |
| Wintergreen Oil (20%) | 13% | |
| Wintergreen Oil (2.5%), Sodium | 75% | 0% |
| Lauryl Sulfate (10%) | | |
| Wintergreen Oil (10%), Sodium | 80% | 7% |
| Lauryl Sulfate (10%) | | |
| Wintergreen (10%), Sodium | 20% | 7% |
| Lauryl Sulfate (2.5%), Lecithin | | |
| (1.25%) | | |
| Wintergreen Oil (10%), Sodium | 20% | 7% |
| Lauryl Sulfate (2.5%), Glycerol | | |
| Monooleate (1.25%) | | |
| Wintergreen Oil (20%), Sodium | 30% | 13% |
| Lauryl Sulfate (1.25%), Glycerol | | |
| Monooleate (1.25%) | | |
| Wintergreen Oil (5%), Sodium | 20% | 0% |
| Lauryl Sulfate (10%), Isopropyl | | |
| alcohol (20%) | | |
| Wintergreen (10%), Sodium | 80% | 7% |
| Lauryl Sulfate (10%) Oleic Acid | | |
| (10%), Isopropyl alcohol (20%) | | |
| Wintergreen (2.5%), Sodium | 60% | 0% |
| Lauryl Sulfate (5%) Oleic Acid (5%), | | |
| Isopropyl alcohol (20%) | | |
| Wintergreen Oil (5%), Sodium | 100% | 7% |
| Lauryl Sulfate (5%), Butyl Lactate | | |
| (10%) | | |
| Wintergreen Oil (5%), Sodium | 60% | 13% |
| Lauryl Sulfate (10%), Butyl Lactate | | |
| (5%) | | |
| Wintergreen Oil (5%), Sodium | 60% | 7% |
| Lauryl Sulfate (10%), Butyl Lactate | | |
| (10%) | | |
| Wintergreen Oil (10%), Sodium | 60% | 19% |
| Lauryl Sulfate (10%), Butyl | | |
| Lactate (5%) | | |
| Wintergreen Oil (20%), Sodium | 100% | 24% |
| Lauryl Sulfate (10%), Butyl | | |
| Lactate (20%), Lecithin (1.25%) | | |
| Wintergreen Oil (10%), Sodium | 100% | 19% |
| Lauryl Sulfate (10%), Butyl | | |
| Lactate (20%), Lecithin (1.25%) | | |
| Wintergreen Oil (5%), Sodium | 80% | 13% |
| Lauryl Sulfate (10%), Butyl Lactate | | |
| (20%), Lecithin (1.25%) | | |
| Wintergreen Oil (5%), Sodium | 100% | 13% |
| Lauryl Sulfate (10%), Butyl Lactate | | |
| (5%), Lecithin (1.25%) | | |

TABLE 8
48-hour efficacy of compositions comprising
wintergreen oil and sodium lauryl sulfate

| | Observed | Expected |
|---|---|---|
| Composition | Efficacy | Efficacy |
| Sodium Lauryl Sulfate (1.25%) | 0% | |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (20%) | 0% | |
| Lecithin (1.25%) | 0% | |
| Glycerol Monooleate (1.25%) | 0% | |
| Butyl Lactate (5%) | 13% | |
| Butyl Lactate (10%) | 7% | |
| Butyl Lactate (20%) | 13% | |
| Wintergreen Oil (2.5%) | 0% | |
| Wintergreen Oil (5%) | 0% | |
| Wintergreen Oil (10%) | 7% | |
| Wintergreen Oil (20%) | 13% | |
| Wintergreen Oil (2.5%), Sodium | 90% | 7% |
| Lauryl Sulfate (10%) | | |
| Wintergreen Oil (10%), Sodium | 100% | 40% |
| Lauryl Sulfate (10%) | | |
| Wintergreen Oil (10%), Sodium | 20% | 40% |
| Lauryl Sulfate (2.5%), Lecithin | | |
| (1.25%) | | |
| Wintergreen Oil (10%), Sodium | 80% | 40% |
| Lauryl Sulfate (2.5%), Glycerol | | |
| Monooleate (1.25%) | | |
| Wintergreen Oil (20%), Sodium | 100% | 93% |
| Lauryl Sulfate (1.25%), Glycerol | | |
| Monooleate (1.25%) | | |
| Wintergreen Oil (5%), Sodium | 100% | 19% |
| Lauryl Sulfate (10%), Isopropyl | | |
| alcohol (20%) | | |
| Wintergreen Oil (10%), Sodium | 100% | 57% |
| Lauryl Sulfate (10%) Oleic Acid | | |
| (10%), Isopropyl alcohol (20%) | | |
| Wintergreen Oil (2.5%), Sodium | 80% | 14% |
| Lauryl Sulfate (5%) Oleic Acid | | |
| (5%), Isopropyl alcohol (20%) | | |
| Wintergreen Oil (5%), Sodium | 100% | 20% |
| Lauryl Sulfate (5%), Butyl Lactate | | |
| (10%) | | |
| Wintergreen Oil (5%), Sodium | 80% | 19% |
| Lauryl Sulfate (10%), Butyl Lactate | | |
| (5%) | | |
| Wintergreen Oil (5%), Sodium | 100% | 14% |
| Lauryl Sulfate (10%), Butyl Lactate | | |
| (10%) | | |
| Wintergreen Oil (10%), Sodium | 100% | 48% |
| Lauryl Sulfate (10%), Butyl | | |
| Lactate (5%) | | |
| Wintergreen Oil (20%), Sodium | 100% | 94% |
| Lauryl Sulfate (10%), Butyl | | |
| Lactate (20%), Lecithin (1.25%) | | |
| Wintergreen Oil (10%), Sodium | 100% | 44% |
| Lauryl Sulfate (10%), Butyl | | |
| Lactate (20%), Lecithin (1.25%) | | |
| Wintergreen Oil (5%), Sodium | 100% | 14% |
| Lauryl Sulfate (10%), Butyl Lactate | | |
| (20%), Lecithin (1.25%) | | |
| Wintergreen Oil (5%), Sodium | 100% | 19% |
| Lauryl Sulfate (10%), Butyl Lactate | | |
| (5%), Lecithin (1.25%) | | |

These results indicate synergistic efficacy for compositions of wintergreen oil (and/or methyl salicylate) having a concentration in a range of approximately 1.25% to 40%, 1.32% to 38%, 1.39% to 36%, 1.47% to 34%, 1.56% to 32%, 1.67% to 30%, 1.79% to 28%, 1.92% to 26%, 2.08% to 24%, 2.27% to 22%, and/or 2.5% to 20%; and the anionic surfactant having a concentration in a range of approximately 0.63% to 20%, 0.66% to 19%, 0.69% to 18%, 0.74% to 17%, 0.78% to 16%, 0.83% to 15%, 0.89% to 14%, 0.96% to 13%, 1.04% to 12%, 1.14% to 11%, and/or 1.25% to 10%.

Without limiting the foregoing, it was noted in the course of experiments that, in suitable circumstances, the tested composition comprising 5% wintergreen oil, 10% sodium lauryl sulfate, 1.25% lecithin, and 5% butyl lactate provided desirable qualities, including a stable microemulsion and strong synergistic efficacy by several measures. Formulations comprising approximately these ingredients may be desirably produced and/or applied to control certain pests as described elsewhere herein. Such formulations may comprise, for example, synergistic pesticidal compositions comprising wintergreen oil (and/or a derivative, a synthetic analog, and/or an agriculturally compatible salt thereof) having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%; sodium lauryl sulfate having a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%; lecithin having a concentration in a range of approximately at least one of: 0.625% to 2.5%, 0.66% to 2.4%, 0.69% to 2.3%, 0.74% to 2.1%, 0.78% to 2%, 0.83% to 1.9%, 0.89% to 1.8%, 0.96% to 1.6%, 1.04% to 1.5%, 1.14% to 1.4%, and 1.25% to 1.3%; and butyl lactate having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%.

### Example 5: Compositions Comprising Geraniol and Sodium Lauryl Sulfate

Compositions comprising geraniol (a pesticidal natural oil), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 9
5-minute efficacy of compositions comprising
geraniol and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (10%) | 0% | |
| Isopropyl alcohol (20%) | 0% | |
| Oleic Acid (10%) | 0% | |
| Oleic Acid (20%) | 0% | |
| NaCl (2.5%) | 0% | |
| NaCl (5%) | 0% | |
| Butyl Lactate (2.5%) | 0% | |
| Butyl Lactate (5%) | 13% | |
| Butyl Lactate (10%) | 7% | |
| Butyl Lactate (20%) | 13% | |
| Lecithin (1.25%) | 0% | |
| Geraniol (2.5%) | 20% | |
| Geraniol (5%) | 7% | |
| Geraniol (10%) | 27% | |
| Geraniol (20%) | 5% | |
| Geraniol (2.5%), Sodium Lauryl | 60% | 20% |
| Sulfate (2.5%) | | |
| Geraniol (2.5%), Sodium Lauryl | 40% | 20% |
| Sulfate (10%) | | |
| Geraniol (5%), Sodium Lauryl | 80% | 14% |
| Sulfate (5%) | | |
| Geraniol (5%), Sodium Lauryl | 20% | 7% |
| Sulfate (2.5%), Isopropyl alcohol | | |
| (10%) | | |
| Geraniol (5%), Sodium Lauryl | 80% | 7% |
| Sulfate (2.5%), Isopropyl alcohol | | |
| (20%) | | |
| Geraniol (2.5%), Sodium Lauryl | 100% | 20% |
| Sulfate (10%), Oleic acid (20%), | | |
| Isopropyl alcohol (20%) | | |
| Geraniol (2.5%), Sodium Lauryl | 80% | 20% |
| Sulfate (10%), Oleic acid (10%), | | |
| Isopropyl alcohol (20%) | | |
| Geraniol (2.5%), Sodium Lauryl | 80% | 26% |
| Sulfate (5%), Oleic acid (10%), | | |
| Isopropyl alcohol (20%) | | |
| Geraniol (2.5%), Sodium Lauryl | 80% | 26% |
| Sulfate (5%), NaCl (2.5%), Oleic | | |
| acid (10%), Isopropyl alcohol (20%) | | |
| Geraniol (2.5%), Sodium Lauryl | 100% | 26% |
| Sulfate (5%), NaCl (5%), Oleic | | |
| acid (10%), Isopropyl alcohol (20%) | | |
| Geraniol (5%), Sodium Lauryl | 60% | 14% |
| Sulfate (2.5%), Butyl Lactate (10%) | | |
| Geraniol (5%), Sodium Lauryl | 40% | 25% |
| Sulfate (5%), Butyl Lactate (5%) | | |
| Geraniol (5%), Sodium Lauryl | 60% | 25% |
| Sulfate (5%), Isopropyl alcohol | | |
| (20%), Butyl Lactate (5%) | | |
| Geraniol (2.5%), Sodium Lauryl | 100% | 35% |
| Sulfate (5%), Isopropyl alcohol | | |
| (20%), Butyl Lactate (5%) | | |
| Geraniol (2.5%), Sodium Lauryl | 100% | 20% |
| Sulfate (2.5%), Isopropyl alcohol | | |
| (10%), Butyl Lactate (2.5%) | | |
| Geraniol (5%), Sodium Lauryl | 60% | 7% |
| Sulfate (2.5%), Isopropyl alcohol | | |
| (10%), Butyl Lactate (2.5%) | | |
| Geraniol (5%), Sodium Lauryl | 80% | 14% |
| Sulfate (5%), Lecithin (1.25%) | | |
| Geraniol (10%), Sodium Lauryl | 100% | 36% |
| Sulfate (10%), Butyl Lactate | | |
| (20%), Lecithin (1.25%) | | |
| Geraniol (10%), Sodium Lauryl | 40% | 32% |
| Sulfate (2.5%), Butyl Lactate | | |
| (10%), Lecithin (1.25%) | | |
| Geraniol (20%), Sodium Lauryl | 40% | 17% |
| Sulfate (1.25%), Butyl Lactate | | |
| (5%), Lecithin (1.25%) | | |
| Geraniol (5%), Sodium Lauryl | 80% | 25% |
| Sulfate (5%) Butyl Lactate (20%), | | |
| Lecithin (1.25%) | | |
| Geraniol (5%), Sodium Lauryl | 20% | 19% |
| Sulfate (2.5%) Butyl Lactate (5%), | | |
| Lecithin (1.25%) | | |

TABLE 10
48-hour efficacy of compositions comprising
geraniol and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Sodium Lauryl Sulfate (10%) | 0% | |
| Isopropyl alcohol (10%) | 0% | |
| Isopropyl alcohol (20%) | 0% | |
| Oleic Acid (10%) | 0% | |
| Oleic Acid (20%) | 0% | |
| NaCl (2.5%) | 0% | |
| NaCl (5%) | 0% | |
| Butyl Lactate (2.5%) | 0% | |
| Butyl Lactate (5%) | 13% | |
| Butyl Lactate (10%) | 7% | |
| Butyl Lactate (20%) | 13% | |
| Lecithin (1.25%) | 0% | |
| Geraniol (2.5%) | 20% | |
| Geraniol (5%) | 7% | |
| Geraniol (10%) | 27% | |
| Geraniol (20%) | 5% | |
| Geraniol (2.5%), Sodium Lauryl | 60% | 7% |
| Sulfate (2.5%) | | |
| Geraniol (2.5%), Sodium Lauryl | 80% | 7% |
| Sulfate (10%) | | |
| Geraniol (5%), Sodium Lauryl | 100% | 19% |
| Sulfate (5%) | | |
| Geraniol (5%), Sodium Lauryl | 60% | 19% |
| Sulfate (2.5%), Isopropyl alcohol | | |
| (10%) | | |
| Geraniol (5%), Sodium Lauryl | 100% | 24% |
| Sulfate (2.5%), Isopropyl alcohol | | |
| (20%) | | |
| Geraniol (2.5%), Sodium Lauryl | 100% | 23% |
| Sulfate (10%), Oleic acid (20%), | | |
| Isopropyl alcohol (20%) | | |
| Geraniol (2.5%), Sodium Lauryl | 100% | 35% |
| Sulfate (10%), Oleic acid (10%), | | |
| Isopropyl alcohol (20%) | | |
| Geraniol (2.5%), Sodium Lauryl | 100% | 39% |
| Sulfate (5%), Oleic acid (10%), | | |
| Isopropyl alcohol (20%) | | |
| Geraniol (2.5%), Sodium Lauryl | 100% | 39% |
| Sulfate (5%), NaCl (2.5%), Oleic | | |
| acid (10%), Isopropyl alcohol (20%) | | |
| Geraniol (2.5%), Sodium Lauryl | 100% | 44% |
| Sulfate (5%), NaCl (5%), Oleic | | |
| acid (10%), Isopropyl alcohol (20%) | | |
| Geraniol (5%), Sodium Lauryl | 80% | 19% |
| Sulfate (2.5%), Butyl Lactate (10%) | | |
| Geraniol (5%), Sodium Lauryl | 100% | 29% |
| Sulfate (5%), Butyl Lactate (5%) | | |
| Geraniol (5%), Sodium Lauryl | 100% | 38% |
| Sulfate (5%), Isopropyl alcohol | | |
| (20%), Butyl Lactate (5%) | | |
| Geraniol (2.5%), Sodium Lauryl | 100% | 34% |
| Sulfate (5%), Isopropyl alcohol | | |
| (20%), Butyl Lactate (5%) | | |
| Geraniol (2.5%), Sodium Lauryl | 100% | 14% |
| Sulfate (2.5%), Isopropyl alcohol | | |
| (10%), Butyl Lactate (2.5%) | | |
| Geraniol (5%), Sodium Lauryl | 100% | 19% |
| Sulfate (2.5%), Isopropyl alcohol | | |
| (10%), Butyl Lactate (2.5%) | | |
| Geraniol (5%), Sodium Lauryl | 100% | 19% |
| Sulfate (5%), Lecithin (1.25%) | | |
| Geraniol (10%), Sodium Lauryl | 100% | 56% |
| Sulfate (10%), Butyl Lactate | | |
| (20%), Lecithin (1.25%) | | |
| Geraniol (10%), Sodium Lauryl | 100% | 56% |
| Sulfate (2.5%), Butyl Lactate | | |
| (10%), Lecithin (1.25%) | | |
| Geraniol (20%), Sodium Lauryl | 100% | 78% |
| Sulfate (1.25%), Butyl Lactate | | |
| (5%), Lecithin (1.25%) | | |
| Geraniol (5%), Sodium Lauryl | 100% | 25% |
| Sulfate (5%) Butyl Lactate (20%), | | |
| Lecithin (1.25%) | | |
| Geraniol (5%), Sodium Lauryl | 100% | 24% |
| Sulfate (2.5%) Butyl Lactate (5%), | | |
| Lecithin (1.25%) | | |

These results indicate synergistic efficacy for compositions of geraniol having a concentration in a range of approximately 1.25% to 40%, 1.32% to 38%, 1.39% to 36%, 1.47% to 34%, 1.56% to 32%, 1.67% to 30%, 1.79% to 28%, 1.92% to 26%, 2.08% to 24%, 2.27% to 22%, and/or 2.5% to 20%; and the anionic surfactant having a concentration in a range of approximately 1.25% to 40%, 1.32% to 38%, 1.39% to 36%, 1.47% to 34%, 1.56% to 32%, 1.67% to 30%, 1.79% to 28%, 1.92% to 26%, 2.08% to 24%, 2.27% to 22%, and/or 2.5% to 20%.

### Example 6: Compositions Comprising Wintergreen Oil, Geraniol, and Sodium Lauryl Sulfate

Compositions comprising wintergreen oil and geraniol (both pesticidal natural oils), sodium lauryl sulfate (a representative anionic surfactant and sulfuric acid monoester), and other ingredients (where applicable) were prepared in water as described above with the relative concentrations as set out in the tables below. Each formulation was tested for efficacy by spraying on German cockroaches, with observations for efficacy at 5-minute and 48-hour intervals. The results are set out in the tables below.

TABLE 11
5-minute efficacy of compositions comprising wintergreen
oil, geraniol, and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Isopropyl alcohol (5%) | 0% | |
| Isopropyl alcohol (10%) | 0% | |
| Lecithin (1.25%) | 0% | |
| Glycerol Monooleate (1.25%) | 0% | |
| Butyl Lactate (2.5%) | 0% | |
| Butyl Lactate (5%) | 13% | |
| NaCl (2.5%) | 0% | |
| Oleic Acid (5%) | 0% | |
| Wintergreen Oil (2.5%) | 0% | |
| Wintergreen Oil (5%) | 0% | |
| Geraniol (2.5%) | 20% | |
| Geraniol (5%) | 7% | |
| Wintergreen Oil (5%), Sodium | 80% | 14% |
| Lauryl Sulfate (5%), Geraniol (5%) | | |
| Wintergreen Oil (2.5%), Sodium | 60% | 14% |
| Lauryl Sulfate (5%), Isopropyl | | |
| alcohol (5%), Geraniol (5%) | | |
| Wintergreen Oil (2.5%), Sodium | 100% | 26% |
| Lauryl Sulfate (5%), Isopropyl | | |
| alcohol (10%), Geraniol (2.5%) | | |
| Wintergreen Oil (2.5%), Sodium | 80% | 14% |
| Lauryl Sulfate (5%), Lecithin | | |
| (1.25%), Geraniol (5%) | | |
| Wintergreen Oil (2.5%), Sodium | 80% | 7% |
| Lauryl Sulfate (2.5%), Lecithin | | |
| (1.25%), Geraniol (5%) | | |
| Wintergreen Oil (5%), Sodium | 60% | 14% |
| Lauryl Sulfate (5%), Lecithin | | |
| (1.25%), Geraniol (5%), Butyl | | |
| Lactate (2.5%) | | |
| Wintergreen Oil (5%), Sodium | 20% | 19% |
| Lauryl Sulfate (2.5%), Lecithin | | |
| (1.25%), Geraniol (5%), Butyl | | |
| Lactate (5%) | | |
| Wintergreen Oil (2.5%), Sodium | 80% | 14% |
| Lauryl Sulfate (5%), Glycerol | | |
| Monooleate (1.25%), Isopropyl | | |
| alcohol (5%), Geraniol (5%) | | |
| Wintergreen Oil (2.5%), Sodium | 80% | 26% |
| Lauryl Sulfate (5%), Glycerol | | |
| Monooleate (1.25%), Isopropyl | | |
| alcohol (10%), Geraniol (2.5%) | | |
| Wintergreen Oil (2.5%), Sodium | 60% | 26% |
| Lauryl Sulfate (5%), Glycerol | | |
| Monooleate (1.25%), NaCl | | |
| (2.5%), Isopropyl alcohol (10%), | | |
| Geraniol (2.5%) | | |
| Wintergreen Oil (2.5%), Sodium | 80% | 14% |
| Lauryl Sulfate (5%), Oleic acid | | |
| (5%), Isopropyl alcohol (20%), | | |
| Geraniol (5%) | | |
| Wintergreen Oil (2.5%), Sodium | 60% | 26% |
| Lauryl Sulfate (5%), Oleic acid | | |
| (5%), Isopropyl alcohol (20%), | | |
| Geraniol (2.5%) | | |
| Wintergreen Oil (2.5%), Sodium | 84% | 14% |
| Lauryl Sulfate (5%), Isopropyl | | |
| alcohol (10%), Geraniol (5%) | | |
| Wintergreen Oil (2.5%), Sodium | 100% | 7% |
| Lauryl Sulfate (10%), Isopropyl | | |
| alcohol (10%), Geraniol (5%) | | |

TABLE 12
48-hour efficacy of compositions comprising wintergreen
oil, geraniol, and sodium lauryl sulfate

| | Observed | Expected |
|---|---|---|
| Composition | Efficacy | Efficacy |
| Sodium Lauryl Sulfate (2.5%) | 0% | |
| Sodium Lauryl Sulfate (5%) | 7% | |
| Isopropyl alcohol (5%) | 0% | |
| Isopropyl alcohol (10%) | 0% | |
| Lecithin (1.25%) | 0% | |
| Glycerol Monooleate (1.25%) | 0% | |
| Butyl Lactate (2.5%) | 0% | |
| Butyl Lactate (5%) | 13% | |
| NaCl (2.5%) | 0% | |
| Oleic Acid (5%) | 0% | |
| Wintergreen Oil (2.5%) | 0% | |
| Wintergreen Oil (5%) | 0% | |
| Geraniol (2.5%) | 20% | |
| Geraniol (5%) | 7% | |
| Wintergreen Oil (5%), Sodium | 100% | 25% |
| Lauryl Sulfate (5%), Geraniol (5%) | | |
| Wintergreen Oil (2.5%), Sodium | 100% | 25% |
| Lauryl Sulfate (5%), Isopropyl | | |
| alcohol (5%), Geraniol (5%) | | |
| Wintergreen Oil (2.5%), Sodium | 100% | 25% |
| Lauryl Sulfate (5%), Isopropyl | | |
| alcohol (10%), Geraniol (2.5%) | | |
| Wintergreen Oil (2.5%), Sodium | 100% | 25% |
| Lauryl Sulfate (5%), Lecithin | | |
| (1.25%), Geraniol (5%) | | |
| Wintergreen Oil (2.5%), Sodium | 60% | 19% |
| Lauryl Sulfate (2.5%), Lecithin | | |
| (1.25%), Geraniol (5%) | | |
| Wintergreen Oil (5%), Sodium | 100% | 25% |
| Lauryl Sulfate (5%), Lecithin | | |
| (1.25%), Geraniol (5%), Butyl | | |
| Lactate (2.5%) | | |
| Wintergreen Oil (5%), Sodium | 100% | 29% |
| Lauryl Sulfate (2.5%), Lecithin | | |
| (1.25%), Geraniol (5%), Butyl | | |
| Lactate (5%) | | |
| Wintergreen Oil (2.5%), Sodium | 100% | 25% |
| Lauryl Sulfate (5%), Glycerol | | |
| Monooleate (1.25%), Isopropyl | | |
| alcohol (5%), Geraniol (5%) | | |
| Wintergreen Oil (2.5%), Sodium | 100% | 25% |
| Lauryl Sulfate (5%), Glycerol | | |
| Monooleate (1.25%), Isopropyl | | |
| alcohol (10%), Geraniol (2.5%) | | |
| Wintergreen Oil (2.5%), Sodium | 100% | 25% |
| Lauryl Sulfate (5%), Glycerol | | |
| Monooleate (1.25%), NaCl (2.5%), | | |
| Isopropyl alcohol (10%), | | |
| Geraniol (2.5%) | | |
| Wintergreen Oil (2.5%), Sodium | 100% | 34% |
| Lauryl Sulfate (5%), Oleic acid | | |
| (5%), Isopropyl alcohol (20%), | | |
| Geraniol (5%) | | |
| Wintergreen Oil (2.5%), Sodium | 100% | 30% |
| Lauryl Sulfate (5%), Oleic acid | | |
| (5%), Isopropyl alcohol (20%), | | |
| Geraniol (2.5%) | | |
| Wintergreen Oil (2.5%), Sodium | 100% | 30% |
| Lauryl Sulfate (5%), Isopropyl | | |
| alcohol (10%), Geraniol (5%) | | |
| Wintergreen Oil (2.5%), Sodium | 100% | 25% |
| Lauryl Sulfate (10%), Isopropyl | | |
| alcohol (10%), Geraniol (5%) | | |

These results indicate synergistic efficacy for compositions of wintergreen oil and geraniol having a ratio of concentrations in a range of approximately 1.25:10 to 10:1.25, 1.32:9.5 to 9.5:1.32, 1.39:9 to 9:1.39, 1.47:8.5 to 8.5:1.47, 1.56:8 to 8:1.56, 1.67:7.5 to 7.5:1.67, 1.79:7 to 7:1.79, 1.92:6.5 to 6.5:1.92, 2.08:6 to 6:2.08, 2.27:5.5 to 5.5:2.27, and/or 2.5:5 to 5:2.5; the combination of wintergreen oil and geraniol having a collective concentration in a range of approximately 2.5% to 20%, 2.6% to 19%, 2.8% to 18%, 2.9% to 17%, 3.1% to 16%, 3.3% to 15%, 3.6% to 14%, 3.8% to 13%, 4.2% to 12%, 4.5% to 11%, and/or 5% to 10%; and the anionic surfactant having a concentration in a range of approximately 1.25% to 10%, 1.32% to 9.5%, 1.39% to 9%, 1.47% to 8.5%, 1.56% to 8%, 1.67% to 7.5%, 1.79% to 7%, 1.92% to 6.5%, 2.08% to 6%, 2.27% to 5.5%, and/or 2.5% to 5%.

Without limiting the foregoing, it was noted in the course of experiments that, in suitable circumstances, the tested compositions comprising approx. 2.5% wintergreen oil, 5% geraniol, 5%-10% sodium lauryl sulfate, and 5%-10% isopropyl alcohol provided desirable qualities, including a stable microemulsion and strong synergistic efficacy by several measures. Formulations comprising approximately these ingredients may be desirably produced and/or applied to control certain pests as described elsewhere herein. Such formulations may comprise, for example, synergistic pesticidal compositions comprising wintergreen oil (and/or a derivative, a synthetic analog, and/or an agriculturally compatible salt thereof) having a concentration in a range of approximately at least one of: 1.25% to 5%, 1.38% to 4.75%, 1.5% to 4.5%, 1.63% to 4.25%, 1.75% to 4%, 1.88% to 3.75%, 2% to 3.5%, 2.13% to 3.25%, 2.25% to 3%, and 2.38% to 2.75%; geraniol (and/or a derivative, a synthetic analog, and/or an agriculturally compatible salt thereof) having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%; sodium lauryl sulfate having a concentration in a range of approximately at least one of: 2.5% to 20%, 2.75% to 19%, 3% to 18%, 3.25% to 17%, 3.5% to 16%, 3.75% to 15%, 4% to 14%, 4.25% to 13%, 4.5% to 12%, 4.75% to 11%, and 5% to 10%; and isopropyl alcohol having a concentration in a range of approximately at least one of: 2.5% to 20%, 2.75% to 19%, 3% to 18%, 3.25% to 17%, 3.5% to 16%, 3.75% to 15%, 4% to 14%, 4.25% to 13%, 4.5% to 12%, 4.75% to 11%, and 5% to 10%.

For instance, in some embodiments the sodium lauryl sulfate has a concentration of approximately 5%, such as a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%. As another example, in some embodiments the sodium lauryl sulfate has a concentration of approximately 10%, such as a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%.

For instance, in some embodiments the isopropyl alcohol has a concentration of approximately 7.5%, such as a concentration in a range of approximately at least one of: 3.5% to 15%, 4% to 14%, 4.5% to 13%, 5% to 12%, 5.5% to 11%, 6% to 10%, 6.5% to 9%, and 7% to 8%. As another example, in some embodiments the isopropyl has a concentration of approximately 10%, such as a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%.

### Chemical Information

Without limiting the foregoing or the appended claims, examples of Chemical Abstract Service (CAS) numbers which may be assigned to certain ingredients disclosed herein include the following:
Isopropanol: CAS #67-63-0
Butyl lactate: CAS #138-22-7
Wintergreen oil: CAS #68917-75-9
Methyl salicylate: CAS #119-36-8
Geraniol: CAS #106-24-1
Thyme oil: CAS #8007-46-3
Thymol: CAS #89-83-8
Oleic acid: CAS #112-80-1
NaCl: CAS #7647-14-5
Sodium lauryl sulfate: CAS #151-21-3
Sodium laureth sulfate: CAS #s 9004-82-4, 13150-00-0, 3088-31-1
Sodium myreth sulfate: CAS #25446-80-4
Ammonium lauryl sulfate: CAS #2235-54-3
Docusate sodium: CAS #10041-19-7
Glycerol monooleate: CAS #s 25496-72-4, 111-03-5
Lecithin: CAS #8002-43-5

It will be understood by those of skill in the art that the above-listed ingredients may be assigned other CAS numbers, or may not have an assigned CAS number, depending on their source and/or other factors. The ingredients disclosed herein are not limited to the CAS numbers disclosed above, which are provided solely for convenience.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

1. A synergistic pesticidal composition comprising:
a pesticidal active ingredient comprising a pesticidal natural oil and/or a derivative, a synthetic analog, and/or an agriculturally compatible salt thereof having a concentration in a range of approximately 1.25% to 40%; and
an anionic surfactant comprising at least one of: a sulfate-, phosphate-, and/or sulfonate-containing ionic compound having a concentration in a range of approximately 0.625% to 20%; and
a solvent.

2. The synergistic pesticidal composition of claim 1 wherein the anionic surfactant comprises at least one of: sodium lauryl sulfate, sodium laureth sulfate, sodium myreth sulfate, ammonium lauryl sulfate, potassium lauryl sulfate, sodium pareth sulfate, ammonium lauryl ether sulfate and docusate sodium salt.

3. The synergistic pesticidal composition of claim 2 wherein the anionic surfactant comprises sodium lauryl sulfate.

4. The synergistic pesticidal composition of claim 1 wherein the pesticidal active ingredient has a concentration in a range of at approximately least one of: 1.25% to 40%, 1.38% to 38%, 1.5% to 36%, 1.63% to 34%, 1.75% to 32%, 1.88% to 30%, 2% to 28%, 2.13% to 26%, 2.25% to 24%, 2.38% to 22%, and 2.5% to 20%.

5. The synergistic pesticidal composition of claim 1 wherein the anionic surfactant has a concentration in a range of at approximately least one of: 0.63% to 20%, 0.69% to 19%, 0.75% to 18%, 0.81% to 17%, 0.88% to 16%, 0.94% to 15%, 1% to 14%, 1.06% to 13%, 1.13% to 12%, 1.19% to 11%, and 1.25% to 10%.

6. The synergistic pesticidal composition of claim 1 wherein the pesticidal active ingredient comprises at least one of: oleic acid, butyl lactate, thyme oil, thymol, wintergreen oil, methyl salicylate, geraniol, and combinations thereof.

7. The synergistic pesticidal composition of claim 6 wherein:
the pesticidal active ingredient comprises oleic acid and has a concentration in a range of approximately 2.5% to 40%;
the anionic surfactant has a concentration in a range of approximately 2.5% to 20%.

8. The synergistic pesticidal composition of claim 7 further comprising isopropyl alcohol having a concentration in a range of approximately 5% to 40%.

9. The synergistic pesticidal composition of claim 6 wherein:
the pesticidal active ingredient comprises butyl lactate and has a concentration in a range of approximately 1.25% to 40%, and preferably has a concentration in a range of approximately 2.5% to 40%; and
the anionic surfactant has a concentration in a range of approximately 1.25% to 20%.

10. The synergistic pesticidal composition of claim 9 further comprising glycerol monooleate having a concentration in a range of approximately 0.625% to 2.5%.

11. The synergistic pesticidal composition of claim 9 further comprising lecithin having a concentration in a range of approximately 0.625% to 2.5%.

12. The synergistic pesticidal composition of claim 9 further comprising isopropyl alcohol having a concentration in a range of approximately 2.5% to 40%.

13. The synergistic pesticidal composition of claim 9 further comprising NaCl having a concentration in a range of approximately 1.25% to 5%.

14. The synergistic pesticidal composition of claim 6 wherein:
the pesticidal active ingredient comprises at least one of: thyme oil and thymol and has a concentration in a range of approximately 2.5% to 40%; and
the anionic surfactant has a concentration in a range of approximately 0.625% to 20%.

15. The synergistic pesticidal composition of claim 14 further comprising lecithin having a concentration in a range of approximately 0.625% to 5%.

16. The synergistic pesticidal composition of claim 14 further comprising butyl lactate having a concentration in a range of approximately 2.5% to 40%.

17. The synergistic pesticidal composition of claim 6 wherein:
the pesticidal active ingredient comprises at least one of: wintergreen oil, methyl salicylate, and geraniol, the pesticidal active ingredient having a concentration in a range of approximately 1.25% to 40%; and
the anionic surfactant has a concentration in a range of approximately 1.25% to 20%.

18. The synergistic pesticidal composition of claim 17 wherein the pesticidal active ingredient comprises geraniol and a second compound comprising at least one of wintergreen oil and methyl salicylate.

19. The synergistic pesticidal composition of claim 18 wherein geraniol and the second compound have a concentration ratio of approximately 1.25:10 to 10:1.25.

20. The synergistic pesticidal composition of claim 18 wherein geraniol and the second ingredient collectively have a concentration in a range of approximately 2.5% to 20%.

21. The synergistic pesticidal composition of claim 17 further comprising lecithin having a concentration in a range of approximately 0.625% to 2.5%.

22. The synergistic pesticidal composition of claim 17 further comprising glycerol monooleate having a concentration in a range of approximately 0.625% to 2.5%.

23. The synergistic pesticidal composition of claim 17 further comprising isopropyl alcohol having a concentration in a range of approximately 2.5% to 40%.

24. The synergistic pesticidal composition of claim 17 further comprising oleic acid having a concentration in a range of approximately 2.5% to 40%.

25. The synergistic pesticidal composition of claim 17 further comprising butyl lactate having a concentration in a range of approximately 1.25% to 40%.

26. The synergistic pesticidal composition of claim 17 further comprising NaCl having a concentration in a range of approximately 1.25% to 10%.

27. The synergistic composition of claim 1 wherein the solvent comprises water having a concentration in a range of approximately 40% to 95%.

28. A synergistic pesticidal concentrate comprising:
a pesticidal active ingredient comprising a pesticidal natural oil and/or a derivative, a synthetic analog, and/or an agriculturally compatible salt thereof having a concentration in a range of approximately 1.25% to 40%; and
an anionic surfactant comprising at least one of: a sulfate-, phosphate-, and/or sulfonate-containing ionic compound;
wherein a concentration ratio of the pesticidal active ingredient to the anionic surfactant is in a range of approximately 1.25:20 to 40:0.625.

29. The synergistic pesticidal concentrate of claim 28 wherein the concentrate comprises an emulsifiable concentrate and the concentrate further comprises an emulsifier.

30. The synergistic pesticidal concentrate of claim 28 wherein the concentrate is at least one of: water-soluble and emulsifiable in water.

31. The synergistic pesticidal concentrate of claim 28 wherein the anionic surfactant comprises at least one of: sodium lauryl sulfate, sodium laureth sulfate, sodium myreth sulfate, ammonium lauryl sulfate, potassium lauryl sulfate, sodium pareth sulfate, ammonium lauryl ether sulfate and docusate sodium salt.

32. The synergistic pesticidal concentrate of claim 31 wherein the anionic surfactant comprises sodium lauryl sulfate.

33. The synergistic pesticidal concentrate of claim 28 wherein the concentration ratio of the pesticidal active ingredient to the anionic surfactant is in a range of approximately at least one of: 1.25:20 to 40%:0.63, 1.38:19 to 38:0.69, 1.50:18 to 36:0.75, 1.63:17 to 34:0.81, 1.75:16 to 32:0.88, 1.88:15 to 30:0.94, 2.00:14 to 28:1, 2.13:13 to 26:1.06, 2.25:12 to 24:1.13, 2.38:11 to 22:1.19, and 2.50:10 to 20:1.25.

34. The synergistic pesticidal concentrate of claim 28 wherein the pesticidal active ingredient comprises at least one of: oleic acid, butyl lactate, thyme oil, thymol, wintergreen oil, methyl salicylate, geraniol, and combinations thereof.

35. The synergistic pesticidal concentrate of claim 34 wherein the pesticidal active ingredient comprises oleic acid and a concentration ratio of the oleic acid to the anionic surfactant is in a range of approximately 2.5:20 to 40:2.5.

36. The synergistic pesticidal concentrate of claim 35 further comprising isopropyl alcohol wherein a concentration ratio of the oleic acid to the isopropyl alcohol is in a range of approximately 40:5 to 2.5:40.

37. The synergistic pesticidal concentrate of claim 34 wherein the pesticidal active ingredient comprises butyl lactate and a concentration ratio of the butyl lactate to the anionic surfactant is in a range of approximately 1.25:20 to 40:1.25.

38. The synergistic pesticidal concentrate of claim 37 further comprising glycerol monooleate wherein a concentration ratio of the butyl lactate to the glycerol monooleate is in a range of approximately 1.25:0.625 to 2.5:40.

39. The synergistic pesticidal concentrate of claim 37 further comprising lecithin wherein a concentration ratio of the butyl lactate to the anionic surfactant is in a range of approximately 1.25:2.5 to 40:0.625.

40. The synergistic pesticidal concentrate of claim 37 further comprising isopropyl alcohol wherein a concentration ratio of the butyl lactate to the isopropyl alcohol is in a range of approximately 1.25:40 to 40:2.5.

41. The synergistic pesticidal concentrate of claim 37 further comprising NaCl wherein a concentration ratio of the butyl lactate to the NaCl is in a range of approximately 1.25:5 to 40:1.25.

42. The synergistic pesticidal concentrate of claim 34 wherein the pesticidal active ingredient comprises at least one of: thyme oil and thymol and a concentration ratio of the pesticidal active ingredient to the anionic surfactant is in a range of approximately 2.5:20 to 40:0.625.

43. The synergistic pesticidal concentrate of claim 42 further comprising lecithin wherein a concentration ratio of the pesticidal active ingredient to the lecithin is in a range of approximately 2.5:5 to 40:0.625.

44. The synergistic pesticidal concentrate of claim 14 further comprising butyl lactate wherein a concentration ratio of the pesticidal active ingredient to the butyl lactate is in a range of approximately 2.5:40 to 40:2.5.

45. The synergistic pesticidal concentrate of claim 34 wherein the pesticidal active ingredient comprises at least one of: wintergreen oil, methyl salicylate, and geraniol and a concentration ratio of the pesticidal active ingredient to the anionic surfactant is in a range of approximately, 1.25:20 to 40:1.25.

46. The synergistic pesticidal concentrate of claim 45 wherein the pesticidal active ingredient comprises geraniol and a second compound comprising at least one of wintergreen oil and methyl salicylate.

47. The synergistic pesticidal concentrate of claim 46 wherein a concentration ratio of geraniol to the second compound is in a range of approximately 1.25:10 to 10:1.25.

48. The synergistic pesticidal concentrate of claim 46 wherein a concentration ratio of the geraniol and the second ingredient to the anionic surfactant is in a range of approximately 2.5:20 to 20:1.25.

49. The synergistic pesticidal concentrate of claim 45 further comprising lecithin wherein a concentration ratio of the pesticidal active ingredient to the lecithin is in a range of approximately 1.25:2.5 to 40:0.625, and preferably in a range of approximately 2.5:2.5 to 20:0.625.

50. The synergistic pesticidal concentrate of claim 45 further comprising glycerol monooleate wherein a concentration ratio of the pesticidal active ingredient to the glycerol monooleate is in a range of approximately 1.25:2.5 to 40:0.625.

51. The synergistic pesticidal concentrate of claim 45 further comprising isopropyl alcohol wherein a concentration ratio of the pesticidal active ingredient to the isopropyl alcohol is in a range of approximately 1.25:40 to 40:2.5.

52. The synergistic pesticidal concentrate of claim 45 further comprising oleic acid wherein a concentration ratio of the pesticidal active ingredient to the oleic acid is in a range of approximately 1.25:40 to 40:2.5.

53. The synergistic pesticidal concentrate of claim 45 further comprising butyl lactate wherein a concentration ratio of the pesticidal active ingredient to the butyl lactate is in a range of approximately 1.25:40 to 40:1.25.

54. The synergistic pesticidal concentrate of claim 45 further comprising NaCl wherein a concentration ratio of the pesticidal active ingredient to the NaCl is in a range of approximately 1.25:10 to 40:1.25.

55. A method of synergistically enhancing the pesticidal activity of a pesticidal composition adapted to control at least one target pest organism comprising:
providing at least one pesticidal active ingredient active for said at least one target pest organism comprising a pesticidal natural oil and/or a derivative, a synthetic analog, and/or an agriculturally compatible salt thereof having a concentration in a range of approximately 1.25% to 40%; and
adding to the at least one pesticidal active ingredient a synergistically effective concentration of an anionic surfactant comprising at least one of: a sulfate-, phosphate-, and/or sulfonate-containing ionic compound having a concentration in a range of approximately 0.625% to 20% to form said synergistic pesticidal composition.

56. (canceled)

57. A method of controlling at least one target pest organism comprising:
providing at least one pesticidal active ingredient active for said at least one target pest organism comprising a pesticidal natural oil and/or a derivative, a synthetic analog, and/or an agriculturally compatible salt thereof having a concentration in a range of approximately 1.25% to 40%;
adding to the at least one pesticidal active ingredient a synergistically effective concentration of an anionic surfactant comprising at least one of: a sulfate-, phosphate-, and/or sulfonate-containing ionic compound having a concentration in a range of approximately 0.625% to 20% to form said synergistic pesticidal composition; and
applying said synergistic pesticidal composition in a pesticidally effective concentration to control said at least one target pest organism.

58. (canceled)

59. A synergistic pesticidal composition comprising:
a pesticidal active ingredient comprising wintergreen oil and/or a derivative, a synthetic analog, and/or an agriculturally compatible salt thereof having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%;
an anionic surfactant comprising sodium lauryl sulfate having a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%, and preferably having a concentration of approximately 10%;
lecithin having a concentration in a range of approximately at least one of: 0.625% to 2.5%, 0.66% to 2.4%, 0.69% to 2.3%, 0.74% to 2.1%, 0.78% to 2%, 0.83% to 1.9%, 0.89% to 1.8%, 0.96% to 1.6%, 1.04% to 1.5%, 1.14% to 1.4%, and 1.25% to 1.3%, and preferably having a concentration of approximately 1.25%; and
butyl lactate having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%.

60. The synergistic pesticidal composition of claim 59 further comprising water having a concentration in a range of approximately 57.5% to 93.75%.

61. A synergistic pesticidal composition comprising:
a pesticidal active ingredient comprising:
wintergreen oil and/or a derivative, a synthetic analog, and/or an agriculturally compatible salt thereof having a concentration in a range of approximately at least one of: 1.25% to 5%, 1.38% to 4.75%, 1.5% to 4.5%, 1.63% to 4.25%, 1.75% to 4%, 1.88% to 3.75%, 2% to 3.5%, 2.13% to 3.25%, 2.25% to 3%, and 2.38% to 2.75%, and preferably having a concentration of approximately 2.5%; and
geraniol and/or a derivative, a synthetic analog, and/or an agriculturally compatible salt thereof having a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, and 4.75 to 5.5%, and preferably having a concentration of approximately 5%;
an anionic surfactant comprising sodium lauryl sulfate having a concentration in a range of approximately at least one of: 2.5% to 20%, 2.75% to 19%, 3% to 18%, 3.25% to 17%, 3.5% to 16%, 3.75% to 15%, 4% to 14%, 4.25% to 13%, 4.5% to 12%, 4.75% to 11%, and 5% to 10%; and
isopropyl alcohol having a concentration in a range of approximately at least one of: 2.5% to 20%, 2.75% to 19%, 3% to 18%, 3.25% to 17%, 3.5% to 16%, 3.75% to 15%, 4% to 14%, 4.25% to 13%, 4.5% to 12%, 4.75% to 11%, and 5% to 10%.

62. The synergistic pesticidal composition of claim 61 wherein the sodium lauryl sulfate has a concentration in a range of approximately at least one of: 2.5% to 10%, 2.75% to 9.5%, 3% to 9%, 3.25% to 8.5%, 3.5% to 8%, 3.75% to 7.5%, 4% to 7%, 4.25% to 6.5%, 4.5% to 6%, 4.75 to 5.5%, and preferably having a concentration of approximately 5%.

63. The synergistic pesticidal composition of claim 61 wherein the sodium lauryl sulfate has a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%, and preferably having a concentration of approximately 10%.

64. The synergistic pesticidal composition of claim 61 wherein the isopropyl alcohol has a concentration in a range of approximately at least one of: 3.5% to 15%, 4% to 14%, 4.5% to 13%, 5% to 12%, 5.5% to 11%, 6% to 10%, 6.5% to 9%, and 7% to 8%, and preferably having a concentration of approximately 7.5%.

65. The synergistic pesticidal composition of claim 61 wherein the isopropyl alcohol has a concentration in a range of approximately at least one of: 5% to 20%, 5.5% to 19%, 6% to 18%, 6.5% to 17%, 7% to 16%, 7.5% to 15%, 8% to 14%, 8.5% to 13%, 9% to 12%, and 9.5% to 11%, and preferably having a concentration of approximately 10%.

66. The synergistic pesticidal composition of claim 61 further comprising water having a concentration in a range of approximately 45% to 91.25%.
